(19) United States
(12) Patent Application Publication
(10) Pub. No.: US 2026/0178956 A1
(43) Pub. Date: Jun. 25, 2026

(54) QUANTUM COMPUTING CIRCUIT AND INFORMATION PROCESSING DEVICE

(71) Applicant: NEC Corporation, Tokyo (JP)

(72) Inventors: Yohei KAWAKAMI, Tokyo (JP); Takaaki AOKI, Tsukuba-shi (JP); Aiko YAMAGUCHI, Tokyo (JP)

(73) Assignee: NEC Corporation, Tokyo (JP)

(21) Appl. No.: 19/426,523

(22) Filed: Dec. 19, 2025

(30) Foreign Application Priority Data
Dec. 23, 2024 (JP) 2024-226543
Feb. 27, 2025 (JP) 2025-030521

(51) Int. Cl. G06N 10/40; G06N 10/20

(52) U.S. Cl. CPC G06N 10/40; G06N 10/20

(57) ABSTRACT

A quantum computing circuit includes a qubit element, and a coupler that causes interaction among three or more of the qubit elements, and the coupler is grounded and has nonlinearity.

### CROSS-REFERENCE TO RELATED APPLICATIONS

The present application claims priority to Japanese patent application No. 2024-226543, filed on Dec. 23, 2024, and Japanese patent application No. 2025-030521, filed on Feb. 27, 2025, the contents of which are incorporated herein by reference.

### BACKGROUND

### Technical Field

The present disclosure relates to a quantum computing circuit and an information processing device.

### Background Art

In quantum computing, multi-body interactions are employed in some cases.

For example, International Publication No. WO 2023/248370 discloses a coupler that couples four qubits via a four-body interaction.

### SUMMARY

In a case where three or more qubits are subjected to a multi-body interaction, it is conceivable that an interaction between two of the three or more qubits may affect the multi-body interaction. It is preferable that the influence of the interaction between two qubits on the multi-body interaction can be reduced.

An example objective of aspects of the present disclosure is to provide a quantum computing circuit and an information processing device that can solve the problems mentioned above.

According to a first example aspect of the present disclosure, a quantum computing circuit includes: a qubit element; and a coupler that causes interaction among three or more of the qubit elements, wherein the coupler is grounded and has nonlinearity. According to a second example aspect of the present disclosure, an information processing device includes: a quantum computing circuit; and a controller, wherein the quantum computing circuit includes: a qubit element; and a coupler that causes interaction among three or more of the qubit elements, and the coupler is grounded and has nonlinearity, and the controller controls the quantum computing circuit to perform quantum computing.

According to the present disclosure, it is expected that the influence of an interaction between two of three or more qubits involved in a multi-body interaction on the multi-body interaction can be made relatively small.

### BRIEF DESCRIPTION OF THE DRAWINGS

FIG. 1 is a diagram showing a configuration example of an information processing device according to at least one of example embodiments.

FIG. 2 is a diagram showing a first example of an implementation of multi-body coupling in a quantum computing circuit according to at least one of the example embodiments.

FIG. 3 is a diagram showing an example of an implementation of multi-body coupling in a case where the coupler is not grounded.

FIG. 4 is a diagram showing an example of a configuration in which two qubit elements 110 are connected without passing through a coupler 120 according to at least one of the example embodiments.

FIG. 5 is a diagram showing an example of a configuration in which two qubit elements 110 are connected via the coupler 120.

FIG. 6 is a diagram showing a first example of a configuration of a coupler according to at least one of the example embodiments.

FIG. 7 is a diagram showing a second example of a configuration of the coupler according to at least one of the example embodiments.

FIG. 8 is a diagram showing a third example of a configuration of the coupler according to at least one of the example embodiments.

FIG. 9 is a diagram showing a second example of an implementation of multi-body coupling in the quantum computing circuit according to at least one of the example embodiments.

FIG. 10 is a diagram showing an example of a network based on the Lechner-Hauke-Zoller (LHZ) scheme using grounded couplers according to at least one of the example embodiments.

FIG. 11 is a diagram showing an example of a configuration of the quantum computing circuit according to at least one of the example embodiments.

FIG. 12 is a diagram showing a configuration example of the information processing device according to at least one of the example embodiments.

FIG. 13 is a schematic block diagram showing a configuration of a computer according to at least one of the example embodiments.

### EXAMPLE EMBODIMENT

Hereinafter, an example embodiment will be described, with reference to the drawings.

In the following description, a dagger symbol may be represented by “+” (a superscript plus).

### First Example Embodiment

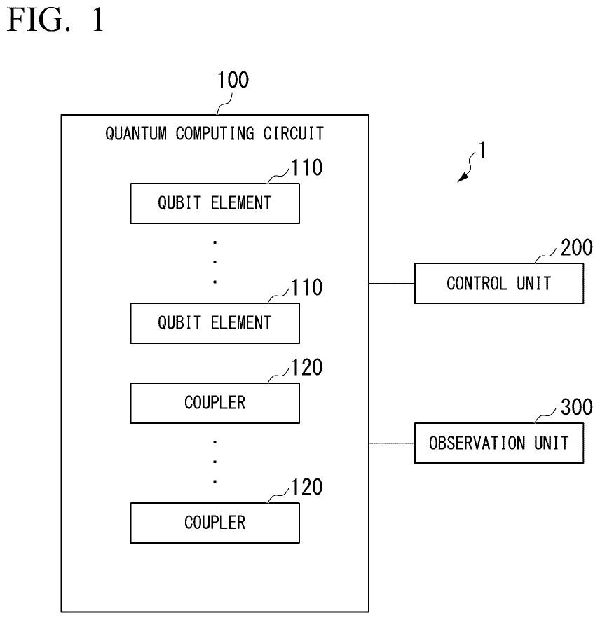

FIG. 1 is a diagram showing a configuration example of the information processing device according to at least one of the example embodiments. In the configuration shown in FIG. 1, an information processing device 1 includes a quantum computing circuit 100, a control unit 200, and an observation unit 300. The quantum computing circuit 100 includes qubit elements 110 and couplers 120.

The information processing device 1 performs quantum computing. For example, the information processing device 1 may perform quantum annealing. The information processing device 1 can also be referred to as a quantum computer. In the case where the information processing device 1 performs quantum annealing, the information processing device can also be referred to as a quantum annealing machine.

The quantum computing circuit 100 executes quantum computing in accordance with control by the control unit 200.

The qubit element 110 is an element for expressing a qubit value. The qubit element 110 may be configured using a JPO (Josephson Parametric Oscillator), but is not limited to this.

The coupler 120 causes interaction among the qubit elements 110. In particular, the coupler 120 causes a multi-body interaction among three or more qubit elements 110. The interaction of the qubit elements 110 herein refers to the correlation of the qubit values represented by the qubit elements 110. The interaction of the qubit elements 110 may also be referred to as interaction between the qubit elements 110. The interaction of the qubit elements 110 may also be referred to as qubit interaction or inter-qubit interaction. The interaction of the qubit elements 110 may also be referred to as coupling of the qubit elements 110, coupling between the qubit elements 110, qubit coupling, or coupling between qubits.

The control unit 200 controls the quantum computing circuit 100 to execute quantum computing. For example, the control unit 200 sets parameter values in quantum computing, such as the strength of multi-body coupling by the coupler 120, according to a problem to be solved by quantum computing, such as a combinatorial optimization problem. Moreover, the control unit 200 controls transitions of the states (quantum states in the qubit elements 110) of the qubit elements 110 by, for example, the temporal variation of a magnetic field input to the qubit elements 110.

The control unit 200 corresponds to an example of the controller.

The observation unit 300 reads the qubit values as a result of quantum computing. Specifically, the observation unit 300, after a predetermined period of time has elapsed from the start of quantum computing, observes the output signals of the qubit elements 110 to detect the quantum states.

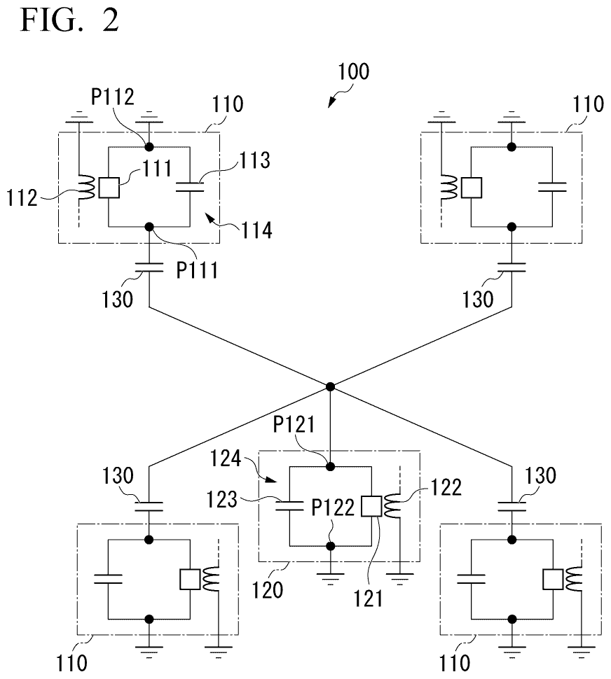

FIG. 2 is a diagram showing a first example of an implementation of multi-body coupling in the quantum computing circuit 100. FIG. 2 shows an example in the case of a four-body interaction, in which four qubit elements 110 and one coupler 120 are connected.

The qubit element 110 includes a Josephson junction loop 111, an inductor 112, and a capacitor 113. The Josephson junction loop 111 and the capacitor 113 are provided in a loop. The loop including the Josephson junction loop 111 and the capacitor 113 is also referred to as a resonant loop 114.

The Josephson junction loop 111 is formed by a superconductor in which a Josephson junction is provided, forming a loop (closed circuit). For example, the Josephson junction loop 111 may be a SQUID (Superconducting Quantum Interference Device) that is a loop having two Josephson junctions, but is not limited thereto.

The inductor 112 generates a magnetic field by allowing current to flow through the inductor 112 itself and applies the magnetic field to the Josephson junction loop 111. By applying a magnetic field with variable intensity from the inductor 112 to the Josephson junction loop 111, the Josephson junction loop 111 can function as a variable inductor (an inductor with variable inductance).

The capacitor 113 represents the capacitance of the resonant loop 114. The structural capacitor of the resonant loop 114 may function as the capacitor 113, or a separate element serving as the capacitor 113 may be provided. The capacitance of the capacitor 113 can also be regarded as the capacitance of the qubit element 110.

By having the Josephson junction loop 111 function as a variable inductor, the resonant loop 114 becomes a loop with a variable resonance frequency. As a result, the qubit element 110 can operate as a parametric oscillator.

In the resonant loop 114, two locations where the Josephson junction loop 111 and the capacitor 113 are connected in parallel constitute the terminals of the qubit element 110. In FIG. 2, the two terminals of the qubit element 110 are denoted as point P111 and point P112.

One of the two terminals (the terminal denoted by point P111) is connected to the coupler 120 via a capacitor 130. The capacitor 130 represents the capacitance in the path connecting the qubit element 110 and the coupler 120.

The other of the two terminals (the terminal denoted by point P112) is grounded.

The coupler 120 includes a Josephson junction loop 121, an inductor 122, and a capacitor 123. The Josephson junction loop 121 and the capacitor 123 are provided in a loop. The loop including the Josephson junction loop 121 and the capacitor 123 is also referred to as a resonant loop 124.

The Josephson junction loop 121 is formed by a superconductor in which a Josephson junction is provided, forming a loop. For example, the Josephson junction loop 121 may be a SQUID, but is not limited thereto. Moreover, only in the case of the coupler, the Josephson junction loop 121 may be a single Josephson junction that does not form a loop. In other words, the qubit element 110 may include the Josephson junction loop 111, and the coupler 120 may include a single Josephson junction instead of the Josephson junction loop 121.

Various nonlinear elements can be used as the Josephson junction loop 121. By configuring the Josephson junction loop 121 using nonlinearity, three or more qubit elements 110 can be made to interact.

Here, the Hamiltonian H of a linear resonator can be expressed as in Expression (1) using capacitance C, inductance L, charge Q, and magnetic flux Φ.

$$\begin{matrix}( Expression 1 ) & \\ H = \frac{{Q}^{2}}{2 C} + \frac{{Φ}^{2}}{2 L} & ( 1 )\end{matrix}$$

In contrast, the Hamiltonian of a nonlinear resonator includes terms of third order or higher with respect to Φ.

The inductor 122 generates a magnetic field by allowing current to flow through the inductor 122 itself and applies the magnetic field to the Josephson junction loop 121. By applying a magnetic field with variable intensity from the inductor 122 to the Josephson junction loop 121, the Josephson junction loop 121 can function as a variable inductor.

The capacitor 123 represents the capacitance of the resonant loop 124. The structural capacitor of the resonant loop 124 may function as the capacitor 123, or a separate element serving as the capacitor 123 may be provided. The capacitance indicated by the capacitor 123 can also be regarded as the capacitance of the coupler 120.

By having the Josephson junction loop 121 function as a variable inductor, the resonant loop 124 becomes a loop with a variable resonance frequency. By adjusting the resonance frequency of the coupler 120 and causing the coupler 120 to interact with each of the qubit elements 110, four qubit elements 110 can be made to undergo a four-body interaction.

In the resonant loop 124, two locations where the Josephson junction loop 121 and the capacitor 123 are connected in parallel constitute the terminals of the coupler 120. In FIG. 2, the two terminals of the coupler 120 are denoted as point P121 and point P122.

One of the two terminals (the terminal denoted by point P121) is connected to the qubit element 110 via a capacitor 130 for each qubit element 110. The other of the two terminals (the terminal denoted by point P122) is grounded.

In the configuration of FIG. 2, in addition to each of the qubit elements 110 being connected to the coupler 120, two of the four qubit elements 110 are connected to each other. By connecting the two qubit elements 110, a two-body interaction occurs between these two qubit elements 110. In the example of FIG. 2, there are six two-body interactions, corresponding to the number of possible combinations of two qubit elements selected from the four qubit elements 110, that is, ₄C₂=6.

The two-body interactions between qubit elements lead to Cross-Kerr interaction. The cross-Kerr interaction adversely affects the multi-body interaction (the four-body interaction in the example of FIG. 2), for example, by altering the resonance frequency of the qubit elements.

The cross-Kerr interaction can be represented as part of the Hamiltonian shown in Expression (2).

$$\begin{matrix}( Expression 2 ) & \\ H = {\sum }_{i = 1}^{4} {H}_{JPO , i} + g ( {a}_{1}^{†} {a}_{2}^{†} {a}_{3} {a}_{4} + {a}_{1}^{†} {a}_{2} {a}_{3}^{†} {a}_{4} + {a}_{1}^{†} {a}_{2} {a}_{3} {a}_{4}^{†} + h . c . ) + {\sum }_{i < j}^{4} {χ}_{i j} {a}_{i}^{†} {a}_{i} {a}_{j}^{†} {a}_{j} & ( 2 )\end{matrix}$$

i and j each indicate an index for identifying one of the four qubit elements. The qubit element identified by index i is also denoted as qubit element i.

H_{JPO,i} denotes the Hamiltonian of an individual qubit element.

g is a coefficient proportional to the product of the couplings g_{gi}(i=1, . . . , 4) between the coupler and the qubit element i. g is expressed as Expression (3).

$$\begin{matrix}( Expression 3 ) & \\ g ∝ {g}_{g 1} {g}_{g 2} {g}_{g 3} {g}_{g 4} & ( 3 )\end{matrix}$$

a⁺ₖ denotes the creation operator.

aₖ denotes the annihilation operator.

“h.c.” is an abbreviation for Hermitian Conjugate, indicating the expression obtained by swapping the presence and absence of the dagger symbol (+). In the case of Expression (2), “h.c.” is represented as shown in Expression (4).

$$\begin{matrix}( Expression 4 ) & \\ h . c . = {a}_{1} {a}_{2} {a}_{3}^{†} {a}_{4}^{†} + {a}_{1} {a}_{2}^{†} {a}_{3} {α}_{4}^{†} + {a}_{1} {a}_{2}^{†} {a}_{3}^{†} {a}_{4} & ( 4 )\end{matrix}$$

Xᵢⱼ is a coefficient proportional to at least the square of the coupling gij between qubit element i and qubit element j. Xᵢⱼ is expressed as Expression (5).

$$\begin{matrix}( Expression 5 ) & \\ {χ}_{ij} ∝ {( {g}_{i j} )}^{2} & ( 5 )\end{matrix}$$

In the quantum computing circuit 100, the coupler 120 is grounded in order to reduce the influence of the Cross-Kerr interaction on the four-body interaction.

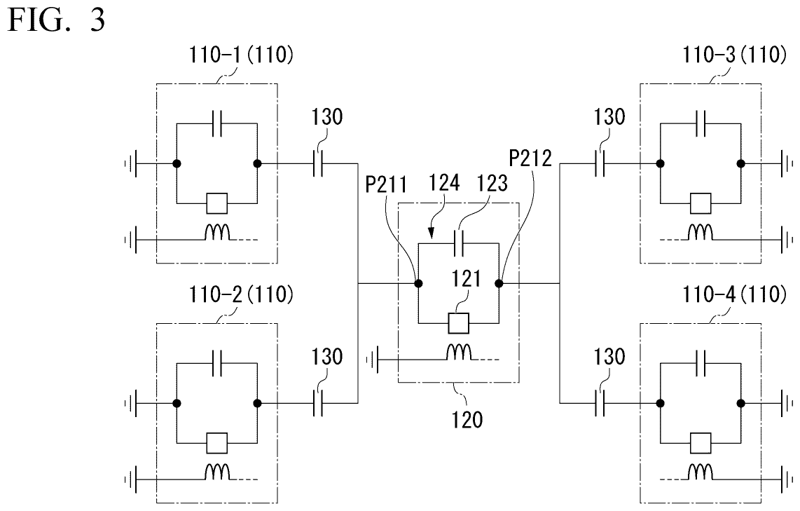

FIG. 3 is a diagram showing an example of an implementation of multi-body coupling in a case where the coupler is not grounded.

The components of FIG. 3 that correspond to the components in FIG. 2 and have the same functions are assigned with the same reference signs (110, 120, 121, 122, 123, 124, and 130), and detailed descriptions thereof are omitted here.

In a case where distinguishing the four qubit elements 110 from one another, they may be referred to as qubit elements 110-1, 110-2, 110-3, and 110-4.

In the example shown in FIG. 3, the coupler 120 is not grounded, and the two terminals indicated by points P211, P212 are each connected to two qubit elements 110. The coupler 120 is connected to the qubit elements 110-1 and 110-2 at the terminal indicated by point P211, and to the qubit elements 110-3 and 110-4 at the terminal indicated by point P212.

Here, consideration is given to a comparison between a case, as in the example of FIG. 2, in which two qubit elements 110 are connected without directly passing through the coupler 120, and a case, as in the connection relationship between qubit elements 110-1 and 110-3 in FIG. 3, in which two qubit elements 110 are connected via the coupler 120.

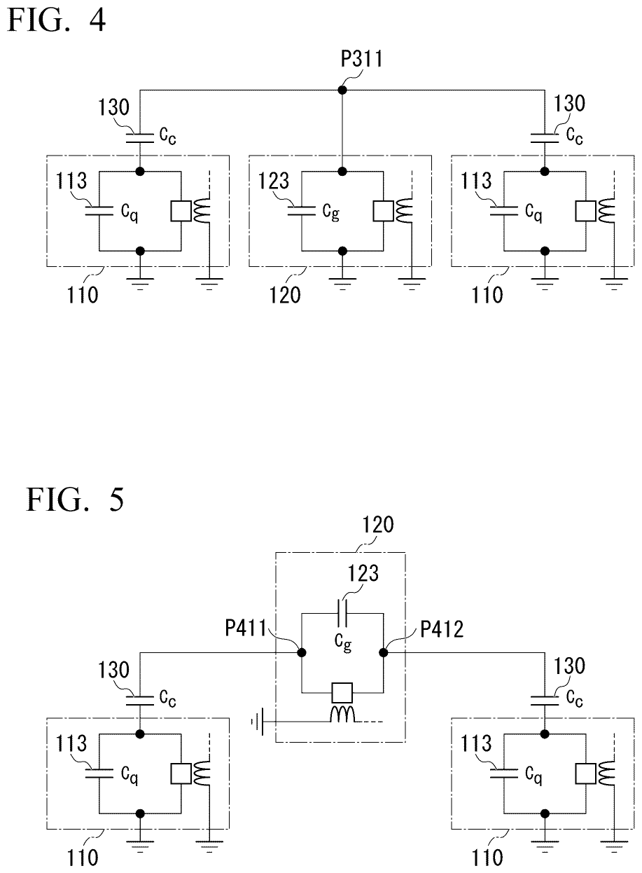

FIG. 4 is a diagram showing an example of a configuration in which two qubit elements 110 are connected without passing through the coupler 120.

In the example of FIG. 4, a path from each of the two qubit elements 110 and a path from the coupler 120 are connected at point P311. As a result, there exists a path that connects the two qubit elements 110 without passing through the coupler 120.

In such a case, the interaction strength g_{q} between the qubit elements 110 is expressed as in Expression (6).

$$\begin{matrix}( Expression 6 ) & \\ {g}_{q} ∝ \frac{{( {C}_{c} )}^{2}}{{{C}_{g} ( {C}_{q} )}^{2}} & ( 6 )\end{matrix}$$

“∝” denotes proportionality.

C_{c} denotes the capacitance of the capacitor 130. That is to say, C_{c} represents the capacitance of the path.

C_{g} denotes the capacitance of the capacitor 123. That is to say, C_{g} represents the capacitance of the coupler 120.

C_{q} denotes the capacitance of the capacitor 113. That is to say, C_{q} represents the capacitance of the qubit element 110.

g_{q} corresponds to the collective coupling gᵢⱼ between the qubit element i and qubit element j described above.

The interaction strength g_{g} between the qubit element 110 and the coupler 120 is expressed as in Expression (7).

$$\begin{matrix}( Expression 7 ) & \\ {g}_{g} ∝ \frac{{C}_{c}}{{C}_{g} {C}_{q}} & ( 7 )\end{matrix}$$

g_{g} corresponds to the collective coupling g_{gi} between the coupler and the qubit element i described above.

It is assumed that the proportionality coefficient is the same in the cases of Expression (6) and Expression (7), the relationship between the interaction strength g_{q} between qubit elements 110 and the interaction strength g_{g} between qubit elements 110 and the coupler 120 is expressed as Expression (8).

$$\begin{matrix}( Expression 8 ) & \\ {g}_{q} = \frac{{C}_{c}}{{C}_{q}} {g}_{g} & ( 8 )\end{matrix}$$

The capacitance C_{q} of the qubit element 110 is considered to be approximately 100 times that of the path capacitance C_{c}. Therefore, the interaction strength g_{q} between the qubit elements 110 is approximately one one-hundredth of the interaction strength g_{g} between the qubit elements 110 and the coupler 120. Thus, in the configuration of the example shown in FIG. 4, the interaction strength g_{q} between the qubit elements 110 can be evaluated as sufficiently small compared with the interaction strength g_{g} between the qubit elements 110 and the coupler 120.

FIG. 5 is a diagram showing an example of a configuration in which two qubit elements 110 are connected via the coupler 120.

In the example of FIG. 5, the coupler 120 is connected to the paths from the qubit elements 110 at each of two terminals indicated by points P411 and P412. As a result, the two qubit elements 110 are connected via the coupler 120.

In such a case, the interaction strength g_{q} between the qubit elements 110 is expressed as in Expression (9).

$$\begin{matrix}( Expression 9 ) & \\ {g}_{q} ∝ \frac{{C}_{c}}{{( {C}_{q} )}^{2}} & ( 9 )\end{matrix}$$

As with the case of FIG. 4, the interaction strength g_{g} between the qubit element 110 and the coupler 120 is expressed as in Expression (7) mentioned above.

It is assumed that the proportionality coefficient is the same in the cases of Expression (3) and Expression (4), the relationship between the interaction strength g_{q} between qubit elements 110 and the interaction strength g_{g} between qubit elements 110 and coupler 120 is expressed as Expression (10).

$$\begin{matrix}( Expression 10 ) & \\ {g}_{q} = \frac{{C}_{c}}{{C}_{q}} {g}_{g} & ( 10 )\end{matrix}$$

It is assumed that the capacitance C_{q} of the qubit element 110 and the capacitance C_{g} of the coupler 120 are approximately equal (C_{q}≈C_{g}), the interaction strength g_{q} between the qubit elements 110 and the interaction strength g_{g} between the qubit element 110 and the coupler 120 are considered to be approximately equal.

The four-body interaction by the coupler 120 can be regarded as being implemented by the interactions between the coupler 120 and each of the four qubit elements 110. Therefore, the strength of the four-body interaction is considered to be proportional to the interaction strength between the qubit elements 110 and the coupler 120.

From this, and from the comparison between the case of FIG. 4 and the case of FIG. 5, it is expected that in the configuration of FIG. 2, in which the coupler 120 is grounded, the effect of the interaction between the qubit elements 110 on the four-body interaction can be reduced to approximately one one-hundredth compared with the configuration of FIG. 3, in which the coupler 120 is not grounded.

As described above, the Josephson junction loop 121 of the coupler 120 may be a SQUID, but is not limited thereto.

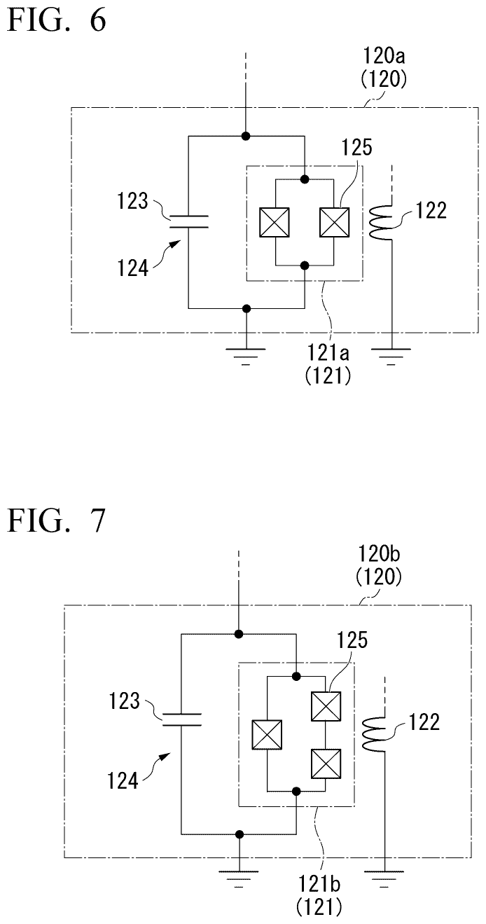

FIG. 6 is a diagram showing a first example of the configuration of the coupler 120. In the example of FIG. 6, the Josephson junction loop 121 is configured using a SQUID. As described above, a SQUID is a loop having two Josephson junctions.

Each Josephson junction may also be referred to as Josephson junction 125.

The Josephson junction loop 121 configured with a SQUID, as in the example of FIG. 6, may also be referred to as Josephson junction loop 121a. The coupler 120, in which the Josephson junction loop 121 is configured using a SQUID, may also be referred to as coupler 120a.

FIG. 7 is a diagram showing a second example of the configuration of the coupler 120. In the example of FIG. 7, the Josephson junction loop 121 is configured as a loop having three or more Josephson junctions 125. FIG. 7 shows an example in which the Josephson junction loop 121 has three Josephson junctions 125. However, the Josephson junction loop 121 may have four or more Josephson junctions 125. Moreover, the number of Josephson junctions on the left side of the Josephson junction loop 121b in FIG. 7 is not limited to one, and multiple Josephson junctions may be provided.

A Josephson junction loop 121 having three or more Josephson junctions 125, as in the example of FIG. 7, may also be referred to as Josephson junction loop 121b. The coupler 120, in which the Josephson junction loop 121 has three or more Josephson junctions 125, may also be referred to as coupler 120b. In such a configuration, the coupler may have negative nonlinearity depending on the strength of the magnetic field generated by a magnetic field application means (for example, inductor 122). In such a case, the negative nonlinearity offsets the positive nonlinearity of the qubit elements, thereby reducing undesirable Cross-Kerr effects.

Here, in the case where the Josephson junction loop 121 is configured using a SQUID, additional operations, such as signal application, are required to cause an odd number of qubit elements 110 to interact, such as in three-body or five-body interactions. In contrast, in the case where the Josephson junction loop 121 is configured as a loop having three or more Josephson junctions, it is expected that an odd number of qubit elements 110 can interact with relatively high accuracy without performing additional operations.

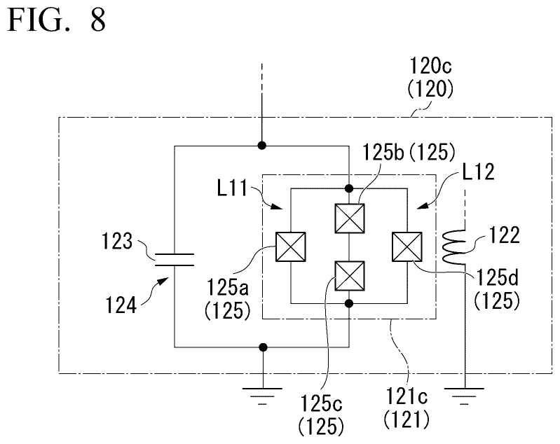

FIG. 8 is a diagram showing a third example of the configuration of the coupler 120. In the example of FIG. 8, the Josephson junction loop 121 is configured using a combination of two loops. Each of the two loops is also referred to as loop L11 and L12. Moreover, in the example of FIG. 8, the Josephson junction loop 121 has four Josephson junctions 125. The four Josephson junctions 125 are also referred to as Josephson junctions 125a, 125b, 125c, and 125d.

Among the four Josephson junctions 125, Josephson junction 125a is included only in loop L11 of loops L11 and L12. Josephson junctions 125b and 125c are common Josephson junctions 125 for loops L11 and L12. In other words, the Josephson junctions 125b and 125c are included in both loops L11 and L12. The Josephson junction 125d is included only in loop L12 of loops L11 and L12.

However, the Josephson junction loop 121 may be configured to include three or more loops. The number of Josephson junctions 125 provided in the Josephson junction loop 121 including multiple loops is not limited to a particular number. For each loop, there may be a Josephson junction 125 included only in that loop, and there may be Josephson junctions 125 shared among multiple loops.

A Josephson junction loop 121 including multiple loops, as in the example of FIG. 8, may also be referred to as Josephson junction loop 121c. The coupler 120, in which the Josephson junction loop 121 includes Josephson junctions 125 having multiple loops, may also be referred to as coupler 120c.

It is expected that, by configuring the Josephson junction loop 121 as a loop having three or more Josephson junctions, an odd number of qubit elements 110 can interact with relatively high accuracy. Moreover, by configuring the Josephson junction loop 121 using a combination of multiple loops, the magnetic field applied to each loop can be adjusted, and the interaction of the qubit elements 110 can be executed with relatively high accuracy.

The coupler 120 is grounded, and the qubit elements 110 need not be grounded.

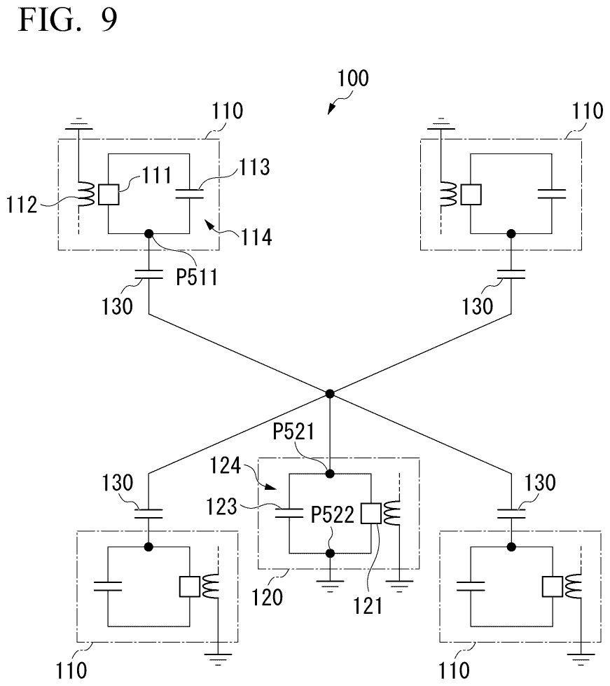

FIG. 9 is a diagram showing a second example of the implementation of multi-body coupling in the quantum computing circuit 100.

The components of FIG. 9 that correspond to the components in FIG. 2 and have the same functions are assigned with the same reference signs (110, 111, 112, 113, 114, 120, 121, 122, 123, 124, 130), and detailed descriptions thereof are omitted here. Moreover, point P511 in FIG. 9 corresponds to point P111 in FIG. 2, point P521 corresponds to point P121, and point P522 corresponds to point P122.

The configuration shown in FIG. 9 differs from the configuration shown in FIG. 2 in that each qubit element 110 is not grounded. In other respects, the configuration shown in FIG. 9 is similar to the configuration shown in FIG. 2.

By not grounding the qubit elements 110, energy leakage from the qubit elements 110 is reduced, the internal Q value increases, and the time during which a coherent state can be maintained is expected to be longer.

By extending the time during which the qubit elements 110 can maintain a coherent state, the time during which bit values (qubit values) can be read from the qubit elements 110 is prolonged. A longer time during which bit values can be read from the qubit elements 110 can also be referred to as a longer lifetime of the qubits.

Here, consider the case in which, in addition to the qubit elements 110, the coupler 120 is also not grounded. In such a case, the four-body interaction by the coupler 120 is likely to be influenced by other circuits, and the accuracy of the four-body interaction may decrease. For example, in a case where one or more of the qubit elements 110 targeted by a first coupler 120 for the four-body interaction are also targeted by a second coupler 120 for a four-body interaction, the four-body interaction by the first coupler 120 is likely to be affected by the four-body interaction by the second coupler 120.

In contrast, with the coupler 120 being grounded, even if the qubit elements 110 are not grounded, the four-body interaction by the coupler 120 is comparatively less affected by other circuits. As a result, the four-body interaction by the coupler 120 is expected to have relatively high accuracy.

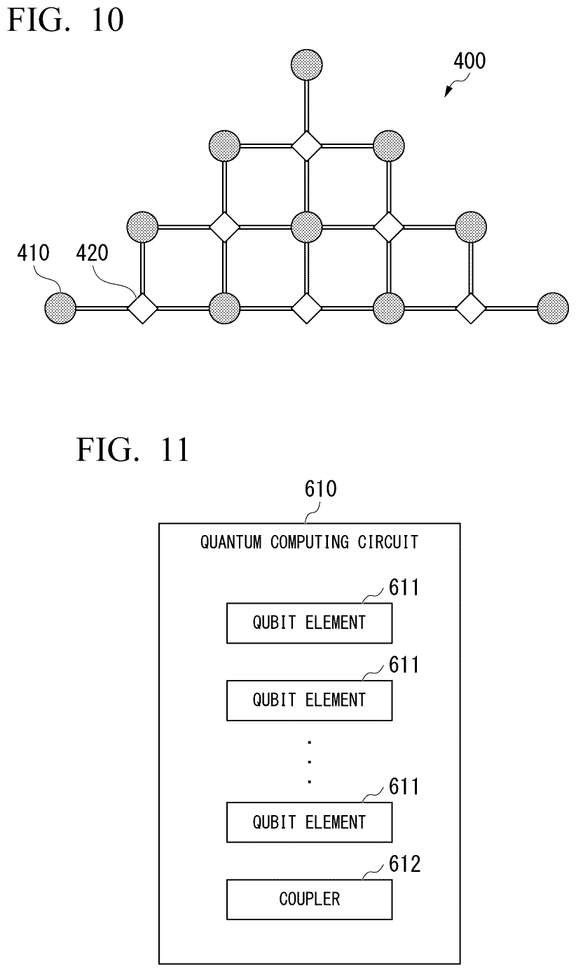

FIG. 10 is a diagram showing an example of a network using grounded couplers. In the configuration shown in FIG. 10, a network 400 includes oscillators 410, represented by circles, and couplers 420, represented by squares (diamonds).

The network 400 corresponds to an example of the quantum computing circuit 100. The oscillators 410 correspond to an example of the qubit elements 110. The couplers 420 correspond to an example of the couplers 120.

The oscillators 410 have positive nonlinearity.

The couplers 420 have negative nonlinearity.

In the configuration shown in FIG. 10, the oscillators 410 with positive nonlinearity and the couplers 420 with negative nonlinearity are alternately connected and spread in two dimensions. Specifically, in both vertical and horizontal directions, the oscillators 410 with positive nonlinearity and the couplers 420 with negative nonlinearity are alternately arranged and connected.

As a result, the nonlinearity is efficiently canceled between the oscillators 410 and the couplers 420, and the Cross-Kerr effects are eliminated.

The vertical and horizontal directions here correspond to examples of the first and second directions.

The structure of the network 400 can be regarded as a mesh structure in which the oscillators 410 and the couplers 420 are alternately connected in both the first and second directions.

In FIG. 10, an example is shown in which the number of oscillators 410 is ten and the number of couplers 420 is six, however, neither the number of oscillators 410 nor the number of couplers 420 included in the network 400 is limited to a particular value.

Furthermore, FIG. 10 shows an example in which the network 400 has a triangular shape as in a network used in the LHZ scheme, however, the shape of the network 400 is not limited to a particular shape and may have various configurations spreading in two dimensions.

Thus, by having oscillators with positive nonlinearity and couplers with negative nonlinearity alternately connected and spreading in two dimensions, it is possible to construct a large-scale multi-bit network while maintaining a structure that cancels the cross-Kerr effects.

The magnitude (absolute value) of the nonlinearity of the oscillator 410 may be the same as the magnitude of the nonlinearity of the coupler 420. This results in a particularly efficient cancellation of the nonlinearity.

Furthermore, even if the nonlinearity of the oscillator 410 is negative and the nonlinearity of the coupler 420 is positive, an effect is obtained in which the nonlinearity is canceled and the cross-Kerr effect is suppressed.

As described above, the coupler 120 is a grounded coupler having nonlinearity and causes three or more qubit elements 110 to interact.

According to the quantum computing circuit 100, the nonlinearity of the coupler 120 allows three or more qubit elements 110 to interact with each other.

Moreover, according to the quantum computing circuit 100, since the coupler 120 is grounded, it is expected that the influence of the interaction between two of the three or more qubit elements that are involved in the multi-body interaction can be made relatively small. In other words, according to the quantum computing circuit 100, it is expected that the interaction between two of the three or more qubit elements 110 involved in the multi-body interaction by the coupler 120 can have a relatively small influence on the multi-body interaction.

Moreover, the coupler 120 causes interaction among three or more qubit elements 110 that are not grounded.

According to the quantum computing circuit 100, since the qubit elements 110 are not grounded, it is expected that the time during which bit values can be read from the qubit elements 110 will be relatively long. Furthermore, according to the quantum computing circuit 100, since the coupler 120 is grounded, it is less affected by other circuits, and it is expected that the coupler 120 can cause interaction among three or more qubit elements 110 relatively accurately.

Moreover, the coupler 120 causes interaction among the qubit elements 110.

According to the quantum computing circuit 100, quantum computing can be performed using various quantum computing methods that employ four-body interactions, such as quantum annealing based on the LHZ scheme.

Furthermore, the coupler 120 (for example, the coupler 420) and the qubit element 110 (for example, the oscillator 410) have nonlinearities of opposite signs.

According to the quantum computing circuit 100, the nonlinearities of the coupler 120 and the qubit element 110 cancel each other, enabling the suppression of the cross-Kerr effect.

Moreover, the absolute values of the nonlinearities of the qubit elements 110 and the couplers 120 are the same. According to the quantum computing circuit 100, the cancellation of nonlinearities occurs particularly efficiently.

Furthermore, in both the first direction and the second direction, the qubit elements 110 and the couplers 120 are alternately connected.

The quantum computing circuit 100 allows a network to be constructed while maintaining a structure that cancels out the cross-Kerr effect. For example, according to the quantum computing circuit 100, a large-scale multi-bit network can be constructed while maintaining a structure that cancels the cross-Kerr effect.

### Second Example Embodiment

FIG. 11 is a diagram showing an example of the configuration of the quantum computing circuit according to at least one of the example embodiments. In the configuration shown in FIG. 11, the quantum computing circuit 610 includes qubit elements 611 and a coupler 612 that causes three or more qubit elements 611 to interact. The coupler 612 is grounded and has nonlinearity.

According to the quantum computing circuit 610, the nonlinearity of the coupler 612 allows three or more qubit elements 611 to interact with each other.

Moreover, according to the quantum computing circuit 610, since the coupler 612 is grounded, it is expected that the influence of the interaction between two of the three or more qubit elements that are involved in the multi-body interaction can be made relatively small. In other words, according to the quantum computing circuit 610, it is expected that the interaction between two of the three or more qubit elements 611 involved in the multi-body interaction by the coupler 612 can have a relatively small influence on the multi-body interaction.

### Third Example Embodiment

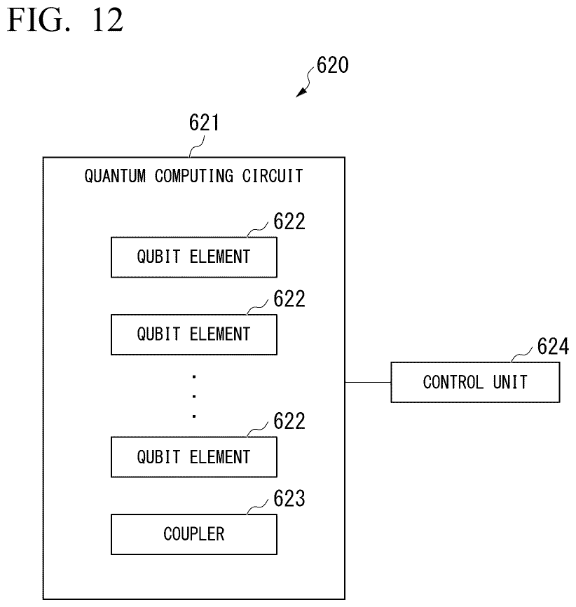

FIG. 12 is a diagram showing a configuration example of the information processing device according to at least one of the example embodiments. In the configuration shown in FIG. 12, an information processing device 620 includes a quantum computing circuit 621 and a control unit 624. The quantum computing circuit 621 includes qubit elements 622 and a coupler 623 that causes three or more qubit elements 622 to interact. The coupler 623 is grounded and has nonlinearity. The control unit 624 controls the quantum computing circuit 621 to execute quantum computing.

The control unit 624 corresponds to an example of the controller.

According to the information processing device 620, the nonlinearity of the coupler 623 allows three or more qubit elements 622 to interact with each other.

Moreover, according to the information processing device 620, since the coupler 623 is grounded, it is expected that the influence of the interaction between two of the three or more qubit elements that are involved in the multi-body interaction can be made relatively small. In other words, according to the information processing device 620, it is expected that the interaction between two of the three or more qubit elements 622 involved in the multi-body interaction by the coupler 623 can have a relatively small influence on the multi-body interaction.

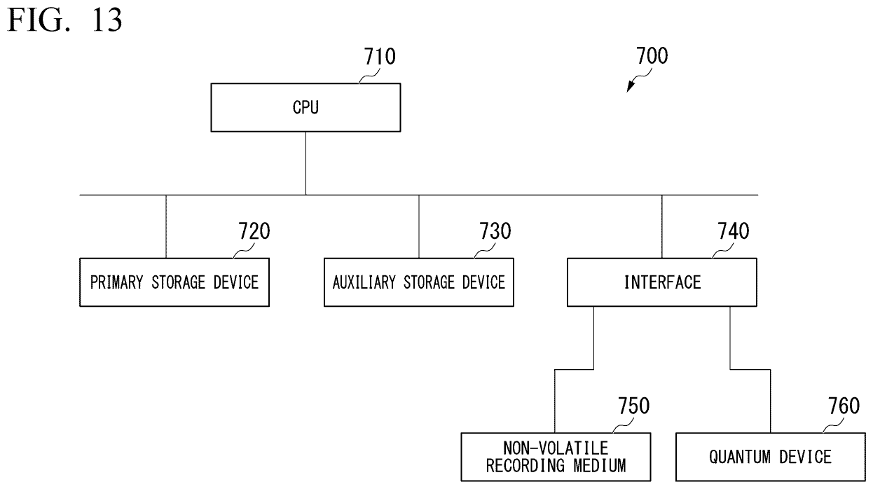

FIG. 13 is a schematic block diagram showing a configuration of a computer according to at least one of the example embodiments.

In the configuration shown in FIG. 13, a computer 700 includes a CPU 710, a primary storage device 720, an auxiliary storage device 730, an interface 740, a non-volatile recording medium 750, and a quantum device 760.

The above information processing device 1 or part thereof may be implemented in the computer 700. In such a case, the quantum computing circuit 100 may be used as the quantum device 760, and the operations of the control unit 200 and the observation unit 300 are stored in the auxiliary storage device 730 in the form of a program. The CPU 710 reads out the program from the auxiliary storage device 730, loads the program onto the primary storage device 720, and executes the processes described above, according to the program. Moreover, the CPU 710 secures a memory storage region in the primary storage device 720 for the processing to be performed by the control unit 200 and the observation unit 300, according to the program.

Furthermore, the interface 740 outputs control signals to the quantum device 760 and reads signals output by the quantum device 760 under the control of CPU 710. The interface 740 also has a port for the non-volatile recording medium 750, and reads information from the non-volatile recording medium 750 and writes information to the non-volatile recording medium 750.

Communication between the information processing device 1 and other devices is executed by the interface 740 having a communication function and communicating according to the control of the CPU 710. Interaction between the information processing device 1 and a user is executed by the interface 740 having an input device and an output device, presenting information to the user through the output device under the control of CPU 710, and accepting user operations through the input device.

Any one or more of the programs described above may be recorded in the non-volatile recording medium 750. In such a case, the interface 740 may read the program from the non-volatile recording medium 750. Then, the CPU 710 directly executes the program read by the interface 740, or it may be temporarily stored in the primary storage device 720 or the auxiliary storage device 730 and then executed.

Note that a program for executing all or part of the processes performed by the control unit 200 and the observation unit 300 may be recorded on a computer-readable recording medium, and the program recorded on the recording medium may be read into and executed on a computer system, to thereby perform the processing of each component. The “computer system” here includes an OS (operating system) and hardware such as peripheral devices.

Moreover, the “computer-readable recording medium” referred to here refers to a portable medium such as a flexible disk, a magnetic optical disk, a ROM (Read Only Memory), and a CD-ROM (Compact Disc Read Only Memory), or a storage device such as a hard disk built into a computer system. The above program may be a program for realizing a part of the functions described above, and may be a program capable of realizing the functions described above in combination with a program already recorded in a computer system.

While the present disclosure has been described above with reference to the example embodiments, the present disclosure is not limited to the example embodiments described above. Various modifications that can be understood by those skilled in the art may be made to the configurations and/or details of the present disclosure, without departing from the scope of the disclosure. Furthermore, the example embodiments described above may be combined with another example embodiment as appropriate.

The whole or part of the example embodiments disclosed above can be described as, but not limited to, the following supplementary notes.

### Supplementary Note 1

A quantum computing circuit comprising:
a qubit element; and
a coupler that causes interaction among three or more of the qubit elements,
wherein
the coupler is grounded and has nonlinearity.

### Supplementary Note 2

The quantum computing circuit according to supplementary note 1, wherein the coupler causes interaction among three or more of the qubit elements that are not grounded.

### Supplementary Note 3

The quantum computing circuit according to supplementary note 1 or 2, wherein
the coupler causes interaction among four of the qubit elements.

### Supplementary Note 4

The quantum computing circuit according to any one of supplementary notes 1 to 3, wherein
a sign of nonlinearity of the coupler is different from that of the qubit element.

### Supplementary note 5

The quantum computing circuit according to supplementary note 4, wherein
an absolute value of the nonlinearity is the same between the qubit element and the coupler.

### Supplementary Note 6

The quantum computing circuit according to supplementary note 4 or 5, wherein
the qubit elements and the couplers are alternately connected in both a first direction and a second direction.

### Supplementary Note 7

An information processing device comprising:
a quantum computing circuit; and a controller,
wherein
the quantum computing circuit includes:
a qubit element; and
a coupler that causes interaction among three or more of the qubit elements, and
the coupler is grounded and has nonlinearity, and
the controller controls the quantum computing circuit to perform quantum computing.

### Supplementary Note 8

The information processing device according to supplementary note 7, wherein
the coupler causes interaction among three or more of the qubit elements that are not grounded.

### Supplementary Note 9

The information processing device according to supplementary note 7 or 8, wherein
the coupler causes interaction among four of the qubit elements.

### Supplementary Note 10

The quantum computing circuit according to any one of supplementary notes 7 to 9, wherein
a sign of nonlinearity of the coupler is different from that of the qubit element.

### Supplementary Note 11

The quantum computing circuit according to supplementary note 10, wherein
an absolute value of the nonlinearity is the same between the qubit element and the coupler.

### Supplementary Note 12

The quantum computing circuit according to supplementary note 10 or 11, wherein
the qubit elements and the couplers are alternately connected in both a first direction and a second direction.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

What is claimed is:

1. A quantum computing circuit comprising:
a qubit element; and
a coupler that causes interaction among three or more of the qubit elements,
wherein
the coupler is grounded and has nonlinearity.

2. The quantum computing circuit according to claim 1, wherein
the coupler causes interaction among three or more of the qubit elements that are not grounded.

3. The quantum computing circuit according to claim 1, wherein
the coupler causes interaction among four of the qubit elements.

4. The quantum computing circuit according to claim 1, wherein
a sign of nonlinearity of the coupler is different from that of the qubit element.

5. The quantum computing circuit according to claim 4, wherein
an absolute value of the nonlinearity is the same between the qubit element and the coupler.

6. The quantum computing circuit according to claim 4, wherein
the qubit elements and the couplers are alternately connected in both a first direction and a second direction.

7. An information processing device comprising:
a quantum computing circuit; and a controller,
wherein
the quantum computing circuit includes:
a qubit element; and
a coupler that causes interaction among three or more of the qubit elements, and
the coupler is grounded and has nonlinearity, and
the controller controls the quantum computing circuit to perform quantum computing.

8. The information processing device according to claim 7, wherein
the coupler causes interaction among three or more of the qubit elements that are not grounded.

9. The information processing device according to claim 7, wherein
the coupler causes interaction among four of the qubit elements.

10. The quantum computing circuit according to claim 7, wherein
a sign of nonlinearity of the coupler is different from that of the qubit element.

11. The quantum computing circuit according to claim 10, wherein
an absolute value of the nonlinearity is the same between the qubit element and the coupler.

12. The quantum computing circuit according to claim 10, wherein
the qubit elements and the couplers are alternately connected in both a first direction and a second direction.
